(19) United States
(12) Patent Application Publication
(10) Pub. No.: US 2023/0340905 A1
(43) Pub. Date: Oct. 26, 2023

(54) Engine’s efficiency by heat preservation, and engines employing this invent

(71) Applicant: Yong Zhang, Carlton (AU)

(72) Inventor: Yong Zhang, Carlton (AU)

(21) Appl. No.: 16/325,721

(22) Filed: Feb. 15, 2019

Related U.S. Application Data
(63) Continuation of application No. PCT/AU2017/000161, filed on Aug. 4, 2017.

(30) Foreign Application Priority Data
Aug. 15, 2016 (AU) 2016903259

(51) Int. Cl. F02B 77/11; F02B 77/02; F02F 3/14; F02F 1/00; F02F 3/00

(52) U.S. Cl. CPC F02B 77/11; F02B 77/02; F02F 1/004; F02F 3/003; F02F 3/14; F02F 2001/008; F02F 2200/02; F05C 2251/048; F05C 2253/025; F05D 2260/221

(57) ABSTRACT

Improving an IC Engine’s thermal efficiency by heat preservation by providing: heat insulation layers to the cylinder, piston crown, combustion chamber and cylinder-head including internal gaps/cavities with or without vacuum; reduced carbonisation of fuel and oil; reduced the thermal shock by exhaust gas recirculation - EGR with control/intake valves, heating and storage tank; improved thermal shock resistance of insulation with flexible/porous thread/fibre and cloth materials bound together by binding with paste, stitching, weaving, braiding or pressed/clamped together; improved distortion resistance using sapphire or tungsten steel; an elongated piston cap or cone; segmented or annular sheet cylinder/liner construction; direct or indirect cooling of fuel injectors with fuel recirculation or spark plugs with high pressure gas jets in pits or slits.

Since the machinability of the heat-resistant material is poor and the requirement for the machining accuracy of the piston that is in contact with the cylinder or the cylinder liner is high, it is possible to use a conventional material such as steel and / or iron and / or aluminum alloy or the like as a part of the piston that is in contact with the cylinder and / or the cylinder liner, and the material that is easier to work with may be used as a portion where the cylinder and / or the cylinder liner that is in contact with the piston. And some or all of the piston and / or cylinder and / or other parts of the cylinder liner will be made of heat-resistant material.

For description conveniency, from now on we will be referring the heat-resistant material that acts as the piston or part of the piston at the piston position as a “piston insulation”. And the heat-resistant material of a portion or all of the cylinders and / or cylinder liner to be a “cylinder insulation layer”. And the heat-resistant material layer serving as a part or all of the cylinder head at the position of the cylinder head is called a “cylinder head insulation”, and the heat-resistant material layer, which forms a part or all of the combustion chamber, is called a “combustion chamber insulation”.

As the piston insulation layer has a small distance with the cylinder insulation layer, between them the heat conductance is high, also there could be carbon deposition in between the piston insulation layer and the cylinder insulation layer, this further increases the heat conduction. As for the piston insulation layer and the upper part of the cylinder insulation layer, the temperature is relatively higher, and their lower parts will have a lower temperature, so that when the piston insulation layer is at the location near the bottom end point of its movement, the heat transferred to the cylinder insulation layer will be more, causing an increasing in the heat loss. And increasing the size of the gap between the piston insulation layer and the cylinder insulation layer will cause too much gas leaking, affecting the normal operation of the engine. So the solution is to make the upper part of the piston insulation cross-section to be smaller, and the cross-section of the lower part to be bigger. That is, for the cylindrical type piston insulation layer, the upper part of the cross-section diameter to be smaller, and the lower part’s cross-section diameter diameter to be larger, and then the cylinder insulation layer also made to the corresponding shapes, such that the gap between the piston insulation layer and the cylinder insulation layer is very small when the piston is at the top end movement position, and the said gap would be relatively larger when the piston is at the bottom end point of its movement position. While for the traditional piston, its upper and lower cross-sections are the same.

When the fuel is not injected into the cylinder-piston assembly, if the engine is still running, such as when the car is slipping, the engine will continue to inhale the cooler air from outside, causing a rapid cooling of the cylinder-piston assembly, creating a thermal shock to the insulation layer inside the piston assembly, which may cause the insulation layer to be damaged prematurely. In order to solve this problem, it can be designed such that the hot exhaust gas can be redirected back into the cylinder so to reduce the thermal shock to the cylinder-piston assembly when the engine stops injecting the fuel. In order to maintain the temperature of the exhausted gas, a heater, such as an electric heater and / or a chemical reaction heater can be used to heating up the exhaust gas flowing path so to heat up the exhaust gas. The easiest way to redirect the exhaust gas back onto the cylinder is to open the exhaust valve with a device, so that the exhaust valve is in the open state while lifting the cam of the intake valve so that the intake valve is at the closed state. Another method is to set up a pipe between the exhaust pipe and the intake pipe, called “return gas pipe”, and with a controlling valve, the controlling valve to be called “gas returning valve”, in front of the connection section of the said intake pipe and the return gas pipe, a valve will be positioned and it is called an “intake valve”, and a valve is provided after the connecting section of the exhaust pipe and the return gas pipe, which is called the “exhaust valve”. When the fuel is not injected into the cylinder, the gas returning valve is opened and the intake valve as well as the exhaust valve will be closed. In order to allow the exhausted gas to be stored locally, a gas tank may be added at an appropriate position between the intake valve and the exhaust valve.

As the heat-resistant materials are mostly brittle materials, they have poor compressive strength and poor tensile strength, when subjected to thermal shock, or when a part of the material experienced pulling tension they are easy to break. When experienced thermal shock, the larger mass/size it is for the whole piece material, the higher the thermal stress it would be produced by this said larger mass, therefore a larger component can be decomposed into smaller components, and they are polymerised together with external forces to add prestressing force, such as with steel parts, smaller pieces are pressed together. These smaller parts may also be joined together with materials of smaller strength or hardness, and then the external forces are applied with prestressing so that so the smaller pieces will be better connected together. It is also possible to connect a portions (portion A) of the smaller pieces while the other portions (portion B) are only in contact or have very small gaps that are not joined together, the materials for the said portion B can be produced with lower strength or hardness, and with added prestressing force, so the smaller pieces will be better connected together. So that when under the thermal shock, the thermal stresses generated can deform the gaps between the smaller pieces, or the deformation or breakage of the material with only happened in lower strength or hardness materials, so the thermal stress between the small members is eliminated to ensure that the small pieces do not break, so the large piece which containing the said smaller pieces will be substantially constant in shape so as to ensure the normal operation of the structure. The previously discussed piston insulation layer, the cylinder insulation layer, the cylinder head insulation layer, and the combustion chamber insulation layer, etc. can be made into the plurality of small parts. In order to prevent the gas leaking in the gaps between the small members, it is possible to sandwich the heat-resistant fibres between the smaller members or the gaps. In addition, in order to allow the thermal stresses generated by the small members to be released so that the stress would not be concentrated in the middle of the structure, the small members may be made to be bending or wavy in shapes, and the contact surfaces or the gaps between the small members may also be curved or wavy, so that the elasticity of the small member is increased and the thermal stress can be released by bending deformation under the thermal shock without resulting in excessive thermal stress to break the small members.

As the heat-resistant fiber material can withstand greater tension, such as Alumina fibre can withstand 18 GPa of tension, it is 36 times the strength compared with ordinary steel, so we can utilise the heat-resistant fibre materials’ high tension property, polymerising the small pieces together to form a bigger piece as we have described above. Some heat-resistant materials such as sapphires also have a greater tensile capacity, and can be made to heat-resistant slender bar shape, together with other said heat-resistant fiber or rope/thread for the aggregating purpose as described above. The manner of aggregation may be carried out in any manner that works such as seam or entanglement, or binding or riveting etc.

The heat-resistant fiber/rope/thread type material may also be woven into a cloth form material, and the heat-resistant cloth may be used to form the aforementioned smaller pieces or sub-pieces of the said smaller pieces. As the cloth structure is relatively soft structure, it’s easy to deform, so one can mix the cloth with other materials, through any method, such as physical or chemical methods to solidify smaller pieces into a more solid piece. For example, the heat-resistant cloth can be mixed with the ceramic soil, sintered at a high temperature, or the heat-resistant cloth can be mixed with a glue to solidify into a solid material piece. Even if such resulting material is cracked under thermal shock, the crack would only be developing in between the heat-resistant cloths, and the cracks would not pass through the heat-resistant cloth, and if the smaller pieces members is made into a bigger piece by an external force, the process of the application of the external force will inhibit the development of cracks, so that the crack will not be extended to such an extent that it would completely separating the heat-resistant cloths, which ensures that the overall structure would basically not be deformed.

The heat-resistant fibers material may also be mixed with heat-resistant material in other forms, such as a powder or liquid or pastry form of heat-resistant material, which is cured into a solid by any means, as described above or it can also be cured into smaller pieces so to form bigger a piece.

Due to the poor tensile strength and its poor resistivity to deformation of the heat-resistant material, it is possible to form a plurality of small holes in the heat-resistant material piece when it is produced. The material piece thus formed has a large deformation capacity, and its thermal shock resistance is also strong. Such a porous heat-resistant material can also be made into the said smaller pieces so to form a bigger piece. The said heat-resistant fiber/rope/thread structure may be embedded in the porous material to further enhance its strength and thermal shock resistance.

The heat-resistant cloth may be put together in a plurality of layers, and then the heat-resistant cloths may be stitched or knitted or riveted or other method to polymerised together to form a heat-resistant material, which may be filled with a heat-resistant material or a porous heat-resistant material among the heat-resistant cloths or even in the gaps in between fibres at the same cloth. Such heat-resistant material or porous heat-resistant material may be solidified or uncured. In order to enhance the resistance to deformation of the multilayer heat resistant cloth material, it is possible to knitting, riveting or stitching the multilayer heat resistant cloths in a partially or wholly oblique manner. Since the heat-resistant cloth is soft, the above mentioned heat-resistant fiber/rope/wire or elongated strip is transferred from one side of the multilayer heat-resistant cloth to the other side when sewing/producing the cloth, the heat-resistant fiber/rope/wire or elongated strip will be stretched so as to be attached to the outermost surface of the cloth, if the fiber/rope/wire or elongated strip were pulled tight it will resulting in the deformation of the heat-resistant cloth, causing it to have a non-flat surface. A similar deformation situation occurs when wrapped or tied or riveted method was used in the said cloth production process.

In order to prevent the heat-resistant cloth from being deformed under the tension of the heat-resistant fiber/rope/wire or elongated strip when in production, it is possible to use a more solid type of material in between the cloth and the said fiber/rope/wire or elongated strip, such material choice can be ceramic, so that the tensile force is sustained by the more solid heat-resistant material to prevent deformation of the said cloth. The heat-resistant cloth, which is polymerized from multilayers of the heat-resistant cloths, may be used on the engine heat-resistant pieces or its smaller compositing pieces, it may also be used in any other application requiring heat or heat shock resistance.

In one embodiment, a plurality of cylindrical pillar pieces having a circular sector cross-sectional shape to form a cylindrical shape, forming a cylinder insulating layer, and the pillar-shaped smaller pieces are sandwiched between heat-resistant cloths and then pressed together by a steel casing.

[symbol] [symbol] [symbol] [symbol] In another embodiment, the sides of the pillar-shaped smaller pieces described at [0019] are made to be in a wavy form, so that the contact surfaces between the small pieces is wavy.

In another embodiment, a plurality of annular thin sheet heat-resistant materials are stacked together to form a cylinder insulation layer, a heat-resistant cloth is sandwiched in between the insulating layers, and then pressed together with a cylinder head and a steel jacket.

An another embodiment: the annular thin sheet heat-resistant material described at [0021] is made to be in a wavy form, so the contact surfaces between the thin sheets of the heat-resistant materials is wavy.

One embodiment of the piston insulation layer is secured to the upper portion of the piston with a heat-resistant fiber-reinforced columnar or circular table-like heat-resistant material. In order to enhance the thermal shock resistance and to reduce the weight, the interior of the piston insulation layer can be made hollow. And in order to enhance it’s strength, it is possible to add stiffeners inside the said cavity or towards its top position in the cavity.

Another embodiment of the piston insulation layer is a columnar or round-like sheet which is stacked with a plurality of sheets of heat-resistant fiber cloths as described in [0018] and solidified with a porous heat-resistant material and sewn together with heat-resistant fibers. The porous heat-resistant material is fixed to the upper part of the piston as a piston insulation. Since the said material may be gradually deformed at high temperatures, one or more materials which are not easily deformable at high temperatures may be used around the side of the piston insulation layer around the multi-layer heat-resistant cloth, such as sapphire or tungsten steel and other materials made into encirclement shapes. In order to make the strengthening the encirclements, stiffeners or struts may be used on the inside of the enclosure.

Another embodiment of the piston insulation layer is to secure a plurality of strip-shaped heat-resistant material at the top of the piston, which is vertically fixed to the piston, and the cross-section of the strip that is parallel to the ground may be of any shape, such as rectangular, hexagonal, round or circular section shape etc. In order to make the bars stronger, they may be connected together in some way or the sides of the stripes are surrounded by some kind of sturdy material.

[symbol] (best mode) [symbol] :

The best mode is: The multi-layer heat-resistant fiber cloth described in [0018] is sewn to the piston with a heat-resistant rope, the piston is made of a conventional material such as steel, iron or aluminum alloy. In between the heat-resistant cloth and the piston a strong thermal shock resistance solid intermediate padding layer can be used, such as fiber reinforced porous heat-resistant materials, mullite or glass-ceramic, etc., the heat-resistant fiber cloth is covered with a sapphire sheet, and sewn Together. In order to be able to sew together, the intermediate layers and the sapphire sheet should also be produced with a plurality of small holes so that the heat resistant rope can pass therethrough.

In order to enhance the thermal shock resistance and to reduce the weight, the aforementioned material’s interior of the intermediate layer may be made hollow, and in order to enhance the strength, the reinforcing ribs or struts may be added to the cavity of the hollow intermediate layer. In order to prevent the said heat-resistant fibrous sheet from being deformed so that some or all of the heat-resistant ropes are made diagonally passing through the multilayer heat-resistant cloth, and the heat-resistant fiber cloth is coated with a heat-resistant material and cured to be a one-body structure. The heat-resistant materials mixed with the heat-resistant cloth such that it’s filled with pores after curing, which will enhance the thermal shock resistance and thermal insulation of the device.

Since the said material from [symbol] may become deformed gradually at high temperatures, the multilayer stacking cloth mentioned at [symbol] may be used around the side of or above the piston insulation layer, and using one or a plurality of layers of materials that are with high resistance of deformation in high temperature, such as sapphire and the like forming wrapping or bracketing layers. In order to have higher strength of the wrapping or bracketing layers, stiffeners and or struts may be used on the inside or outside of the enclosure or the bracketing layer. The shape of the piston insulation is made to be like a rounded table shape. The multi-layer stacked, and mixed with porous heat-resistant material of the ring shape heat-resistant cloth will be sintered into a relatively strong solid, connected to the upper part of the cylinder, to form a cylinder insulation. The lower part of the cylinder which located at the lower part of the piston ring, is made with traditional materials such as steel, iron or aluminum alloy. The outer jacket layer of the cylinder insulation layer is made with steel, iron or aluminum alloy etc. so to increase the strength of the insulation layer. The internal pores of the cylinder insulation is also made to be in the rounded shape and is located close to the piston insulation layer. Inside the cylinder insulation layer, it is also possible to install a wrapping or bracketing layer so that it is not easily deformable at high temperatures as described in [0026] 1).

In the lower part of the cylinder head, a insulation layer can be sewn to it, such that the heat-resistant cloth is stacked in a multi-layer structure and mixed with a porous heat-resistant material similar to that described in [0026] 2) to form a relatively strong solid, that forms a cylinder head insulation. A hole is created, such that it is the passage path for the intake pipe, and the exhaust pipe, the fuel injection nozzle as well as the spark plug. In order for the cylinder head insulation layer not to be easily deformed, a portion or all of the heat resistant rope is diagonally passed through the said heat-resistant cloth.

Between the heat-resistant cloth and the cylinder head, a strong thermal shock resistance intermediate layer material can be used, such material choice can be fiber reinforced porous heat-resistant materials, mullite or glass-ceramic, etc. The heat-resistant fiber cloth is to be covered with a sapphire sheet. In order for the structure to be sewn together, the said intermediate layer material and the said sapphire sheet should also be produced with a plurality of small holes through which the heat resistant rope can pass through. In order to enhance the thermal shock resistance and to reduce the weight, the interior of the intermediate layer may be made hollow, and in order to enhance the strength, the reinforcing ribs or struts may be added to the cavity of the hollow in the intermediate layer.

In order to enhance the strength of the cylinder head insulation layer, the outer circumference of the cylinder head to be made structurally extending outward and downward to form a hat shape structure, which wraps around the upper and the side of the cylinder lid insulation layer, and then the external force is used to press the cylinder head insulation layer onto the cylinder Insulation layer, with such an external force applied to it, the cylinder insulation layer will not be having outward expansion, nor can it be compressed, even if there is small cracks presenting in it, due to the fact that the layer is tightly pressed, so that cracks can not be extended. The cylinder head insulation layer is sewn on the cylinder head, under the heat-resistant ropes’ tension and the cylinder insulation layers pressure, the cylinder head insulation layer will not be producing straight through cracks easily in the structure, thus ensuring the cylinder insulation layer and the cylinder head insulation layer not to be deformed easily.

1-98. (canceled)

99. A type of heat resistant material piston engine comprising heat-resistant material, wherein the heat-resistant material partially or wholly comprises a plurality of smaller members/pieces which are pressed together by an external force, wherein the heat-resistant material form part or all of a piston insulation layer, and/or part or all of a cylinder insulation layer, and/or part or all of a cylinder head insulation layer, and/or part or all of a combustion chamber insulation layer.

100. A type of engine as in claim 99, wherein the smaller members of the heat-resistant material are partially joined together, while other parts are only in contact and are not connected together.

101. A type of engine as in claim 99, wherein the smaller members of the heat-resistant material are compressed together, the smaller members being made into a wire form, and/or in fiber form, and/or in a slim strip form which is tensile resistant and heat resistant, wherein a method of compression may be carried out by seaming, and/or wrapping and/or tying and/or riveting.

102. A type of engine as in claim 101, employing the fiber form and/or the thread form of the heat-resistant material sewing into cloth form, then employing the cloth form materials producing devices and/or smaller devices that form part or all of the piston insulation layer, and/or part or all of the cylinder insulation layer, and/or part or all of the cylinder head insulation layer, and/or part or all of the combustion chamber insulation layer.

103. A type of reciprocal piston engine comprising a heat-resistant thermal insulation material layer for a piston and/or cylinder and/or cylinder head and/or combustion chamber, wherein the thermal insulation material layer contains one or more cracks.

104. A type of engine as claim 103, wherein the crack or cracks are partially or fully filled with materials with lower tensile strength, so that the materials will form the one or more cracks under thermal shock.
